(19) United States
(12) Patent Application Publication
(10) Pub. No.: US 2013/0231169 A1
(43) Pub. Date: Sep. 5, 2013

(54) Poker Game

(71) Applicant: ROLLED UP GAMING PARTNERS, Reno, NV (US)

(72) Inventors: Richard Brian Lopez, Reno, NV (US); Patrick M. Crawford, Reno, NV (US)

(73) Assignee: ROLLED UP GAMING PARTNERS, Reno, NV (US)

(21) Appl. No.: 13/738,998

(22) Filed: Apr. 11, 2013

Related U.S. Application Data
(63) Continuation of application No. 13/066,875, filed on Apr. 27, 2011, now abandoned.
Application No. 13/066,875 is a continuation of application No. 12/802,599, filed on Jun. 10, 2010, now abandoned.
Application No. 12/802,599 is a continuation of application No. 12/384,756, filed on Apr. 7, 2009, now abandoned.
Application No. 12/384,756 is a continuation-in-part of application No. 11/732,529, filed on Apr. 4, 2007, now abandoned.

(51) Int. Cl. G07F 17/32

(52) U.S. Cl. CPC G07F 17/3293
USPC 463/13

(57) ABSTRACT

The method of the present invention involves a poker game in which a player is dealt a plurality of cards from which he makes a plurality, N, of starting hands. Each starting hand has a wager associated with it. After the player sets his starting hands, an opposing house starting hand is created, preferably from a number of cards capable of creating a plurality of starting hands. The player's first starting hand is completed as is the opposing house hand. If the player's first completed hand beats the opposing hand, the player receives an award and the player's next completed hand is compared to the opposing hand. If the player's first completed hand loses to the opposing hand, all wagers are lost and the game is over. This process continues until all N starting hands have been completed and evaluated or until the player loses the nth starting hand resulting in all nth to N wagers being lost.

### CROSS-REFERENCE TO RELATED APPLICATIONS

This patent application is a continuation of application Ser. No 12/802,599 which is a continuation of application Ser. No. 12/384,756, filed Apr. 7, 2009, which is continuation-in-part of application Ser. No. 11/732,529 filed Apr. 4, 2007.

### BACKGROUND OF THE INVENTION

The present invention is an improved poker game. There are a number of variations of poker games. In some variations, such as Hold 'Em and Omaha, each player is dealt an initial starting hand of two or four cards respectively. In both Hold 'Em and Omaha, after each player is dealt an initial starting hand, five community cards (or a board) is dealt and each player makes the best possible five-card and using a combination of the starting hands and the board cards. In other poker games such as Seven-Card Stud and Razz, each player's starting hand consists of three cards and then each player receives four additional cards to complete the individual's hand. In a typical poker game, once an individual's hand is completed it is compared against the hands of one or more opponents and the winner receives an award. In other poker games, such as video poker, the player's completed hand is compared against a pay table to determine if any award will be made.

### SUMMARY OF THE INVENTION

The present invention is ideally suited for Hold 'Em, but may be applied to other poker variations. It may be played either in a live format or on an electronic gaming machine. The invention is characterized by a player receiving a plurality of cards from which he makes a plurality of starting hands. For instance, in the preferred embodiment using Hold 'Em, the player receives six cards from which he makes three starting hands. In the preferred embodiment, each starting hand will have a separate wager associated with it. Preferably, each wager will be equal and will be determined prior to the player receiving his initial cards and will remain constant throughout the game. The player's opponent, typically a house or bank, also may receive a number of cards capable of making a plurality of starting hands. However, in the preferred embodiment, the house will only make a single starting hand and the excess cards will be discarded. The number of cards the house receives may be the same as the player or may be different.

Once the player has set his plurality of starting hands and the house has set its starting hand, the hands are completed. In the preferred Hold 'Em embodiment, this is done by dealing a board of five community cards and the same five community cards are used to complete all of the player's starting hands as well as the houses starting hand. After the hands have been completed, the houses hand and player's hands are compared. It the player's first hand is of higher value than the house's hand, the player receives an award based upon the wager associated with the first hand. If the player wins the first hand, his second hand is compared to the house's hand and an award paid if it is of higher value than the house's hand. However, if the player loses the first hand, the wagers associated with the first hand, the second hand—and any subsequent hand—is forfeited. Similarly, the third hand (and any other subsequent hand) is only eligible for an award it the player wins the prior hand.

As used herein, “win” may mean anything as defined by the house rules for the game. But typically, “win” will mean any hand having a higher poker value than the player's opponent. It may also mean a tie, such as when the community cards form a straight and neither the house not the player can make a higher straight or flush. Alternatively, ties may be counted as a loss. In the preferred embodiment, a tie will be treated as “no action” and the player's wager associated with the hand will not be forfeited and the subsequent hand will be evaluated.

The amount the player is awarded for a win is preferably determined by a pay table. Preferably the pay table amounts will increase for subsequent hands, such that the player generally receives larger awards for winning a subsequent hand than for winning a prior hand. The pay table may be simple such that the player's award is the same regardless of the rank of hand he makes, or the pay table may be complex such that the rank of the player's hand determines the amount of the award. In the preferred embodiment, a simple pay table is used for all three hands—the first hand pays even money for a win, the second hand pays three times the wager and the third hand pays ten times the wager.

In alternative embodiments, the player may make wagers in addition to or in lieu of the primary wagers discussed previously. For instance, in one alternative embodiment, the player may make one or more insurance wagers. An insurance wager as used herein would allow a player to proceed to at least one subsequent hand even if a prior hand was lost. The insurance wager may be specific to one associated losing hand, or in alternative arrangements, it may cover all hands. In the embodiments where a single insurance wager may cover multiple hands, the number of hands that are insured, may be determined by the size of the wager.

Another alternative wager that may be made in alternative embodiments is a side wager on the poker hand strength of the initial cards dealt to the player. Preferably, this wager is paid against a pay table where higher ranked poker hands pay of greater amounts. In some variations, the payout for the side wager will be independent of how the player divides the initial cards into starting hands or whether the starting hands beat the dealer. In other variations, the player may have to set the starting hands in a certain combination to receive a payout or the payout may be based upon how the starting hands fare against the dealer. For instance, in the preferred embodiment where the player is dealt an initial hand of six cards that he divides into three two-card starting hands to play the game of Hold 'Em, the side wager may be based on the poker ranking of the initial six cards dealt. The poker ranking could include the traditional ranking of five-card poker hands or other alternatives, such as six-card hands or four-card hands. In the example where the four-card poker ranking is used, the wager may only be paid on the four cards that form the player's first and second hands as an example of the side wager being dependent on how the player sets the three starting hands. As an example of the side wager being dependent on how the player's starting hands fare against the dealer, the amount paid for side wager may be paid only if the player beats the dealer on one or more starting hands. Alternatively, the amount paid for the side wager (based of the same pay table as before) may be modified, for instance doubled, if the player loses all three of the primary wagers.

### DESCRIPTION OF THE PRIOR ART

Traditional poker played in a casino is a game where the players bet against each other and the house takes a percentage of the bets. However, other poker variants have become popular where a player or multiple players may play a game against the house. These games are played in the pit, alongside other traditional casino games such as black jack. One such game is Three Card Poker. In Three Card Poker the player makes an ante and then the player and house each receive three cards. The player then determines if he wishes to play or forfeit his ante. If he does not wish to play on he folds and forfeits his ante. If he wishes to play on he places another wager matching the ante. Then the dealer reveals the house hand and if it is a Queen high or better hand (i.e., a qualifying hand) the house plays against the player(s). If the house doesn't qualify, all players that elected to play on receive a matching wager on their ante, but there is no action on the second wager. If the house qualifies, the house hand is compared to the player's hand or players' hands, and if the player(s) wins( ) both wagers are paid a matching award. The game also offers a third wager option where the rank of the player's hand is evaluated against a complex pay table to determine if an award is paid, and of what size the award would be.

Another such house game is Pai Gow Poker. In Pai Gow Poker the player places a single wager and receives seven cards. The dealer also receives seven cards. The player separates his cards into a five-card hand and a two-card hand. The dealer does the same. The hands are then revealed and if the player's five-card hand beats the dealer's five-card hand and the player's two-card hand beats the dealer's two-card hand the player wins an award matching his wager. If the player loses both hands, the player loses his wager. If the player loses one hand and wins one hand, the game is a push. The house has an edge in the game by requiring the player to pay a five percent commission on all winning wagers.

Poker games may also be played on an electronic gaming machine. Electronic gaming machines, also generally referred to as slot machines, have long been a mainstay of the gaming industry. The most popular form of video poker is five-card draw. In five-card draw, the player places a wager before receiving a starting hand of five cards. The player may discard none to all of the cards in the starting hand to receive replacement cards. The five card hand formed by the held cards and the replacement cards is then compared to a complex pay table to determine a payout, if any, to be given to the player. Another variation of the standard five-card draw video poker game is Multi-Strike Poker. This game is described in U.S. Pat. No. 6,612,927.

It is therefore an object of the present invention to provide a new type of poker that offers players a new and stimulating type of strategic decision.

### BRIEF DESCRIPTION OF THE DRAWINGS

FIG. 1 is a table layout for playing the preferred embodiment with a dealer.

FIG. 2 is a gaming machine that may be used for playing the present invention electronically.

FIG. 3 is schematic of the internal components of a gaming machine such as the one shown in FIG. 2.

### DETAILED DESCRIPTION OF THE PREFERRED EMBODIMENTS

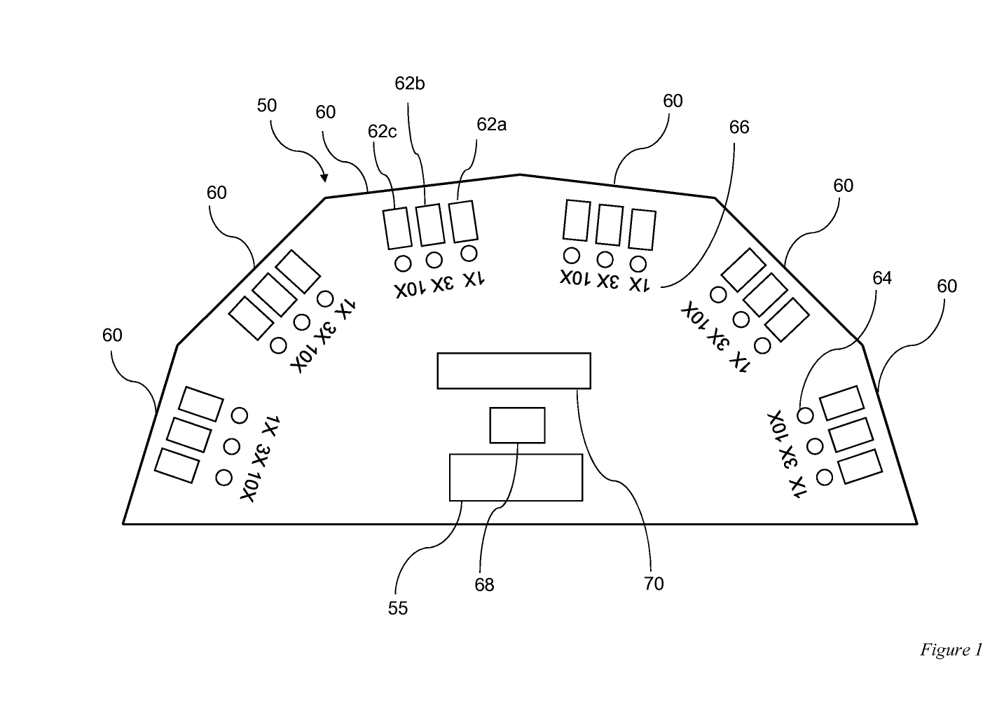

One embodiment of the present invention may be played on a table 50 as shown in FIG. 1. A dealer employed by the casino stands behind the table 50 with access to a tray 55. The tray 55 holds chips of various denominations used to payout players' winning wagers. Each player sits at the table 50 behind a player position 60. In the preferred embodiment each player position has a first hand position 62a, a second hand position 62b and a third hand position 62c. Each hand position 62 also has an associated wager circle 64 located directly in front of the hand position 62 where players place their wagers on the hand. Preferably, the table 50 also has at least one legend 66 showing the pay table associated with each hand. In the preferred embodiment as illustrated by the legend 66 on the table 50 shown in FIG. 1, the first wager pays even money for a win, the second wager pays three to one for a win and the third wager pays ten to one for a win.

Play of the game begins by each player placing a wager in the wager circles 64 of their player position 60. In the preferred embodiment, a wager must be placed in each wager circle 64 of each occupied player position 50 and each wager must be of equal value. Once all of the wagers have been placed, the dealer deals a number of cards to each occupied player position 60 and to the dealer from a randomly shuffled deck of cards. Preferably it is a standard fifty-two card deck. In the preferred embodiment, the dealer deals six cards to each player as well as six cards to the dealer. The player then examines his number of cards and divides them into the required number of starting hands and places each starting hand in its respective hand position 62. In the preferred embodiment, each player makes three starting hands consisting of two cards. The first starting hand is placed in the first position 62a. The second starting hand is placed in the second position 62b. The third starting hand is placed in the third position 62c. Preferably, the cards are dealt face down and players are not permitted to look at the cards of the other players. Each hand is placed face down in its hand position 62.

Once each player has placed his hands in the desired hand positions 62, the dealer turns his cards face up and forms one starting hand. In the preferred embodiment, this will involve making one two-card starting hand from six cards. The dealer will preferably use pre-defined rules to create the house starting hand. In the preferred embodiment, the rules dictate that the dealer plays the highest pair in his six cards and if no pairs are present, the dealer plays his two highest cards in rank. Other rules for setting the house hand may be used. These rules may result in either a statistically superior or inferior starting hand for the house, as desired. It will be appreciated by those skilled in the art that adjusting the rules to arrive at a statistically superior starting hand will lower the player's expected return on his wager, while a statistically inferior hand will raise the player's expected return. Once the dealer has determined the “house-way” to set his starting hand, the remaining cards from the dealer's hand are discarded and the house's starting hand is placed face up in a house starting hand position 68.

After the dealer has set the house starting hand, the players' first starting hands located in the first hand positions 62a may be turned face up. Alternatively, all of the players starting hands may be turned face up. The dealer will then complete at least the player's first starting hand, as well as the dealer's hand. In the preferred embodiment where the game is Hold 'Em, this is done simultaneously by dealing five community cards. The community cards are placed in a community card location 70. Preferably, these same community cards will be used to complete the player's other hands as well. Thus, it makes no difference if all of the player's hands are turned face up at once. After the player's first hand is completed, the dealer will compare it to the dealer's completed hand. If the player loses the first hand, the dealer will collect not only the player's first hand, but also each additional hand along with each wager in the player's associated wager circles 64. Thus, losing the first hand costs the player not only his first wager, but all other wagers as well. If the player wins the first hand, the dealer pays the player according to the legend 66, i.e., an amount equal to one times the amount in the wager circle 64 associated with the first hand position 62a. When there are more than one occupied player position 60 at the table, the dealer will preferably evaluate the players' hands in an orderly manner. For instance, the dealer may evaluate the left-most player's first hand first and then move clock-wise around the table evaluating the first hand of any additional players.

If the player wins the first hand, the dealer will also evaluate the player's second hand formed by the cards in the player's second hand position 62b and the cards in the community card location 70 and compare the player's second hand to the dealer's hand. Again, if the player loses the second hand the dealer will collect the player's second starting hand and third starting hand and the wagers associated therewith. If the player wins the second hand, the dealer will make the payout defined by the legend 66 and proceed to evaluate the player's third hand and make any required payouts.

Once all of the players hands have either been completed and evaluated or have been “killed” by virtue of the player losing a previous hand, the game is completed and play of the game starts over by players replacing wagers in the wager circles 64.

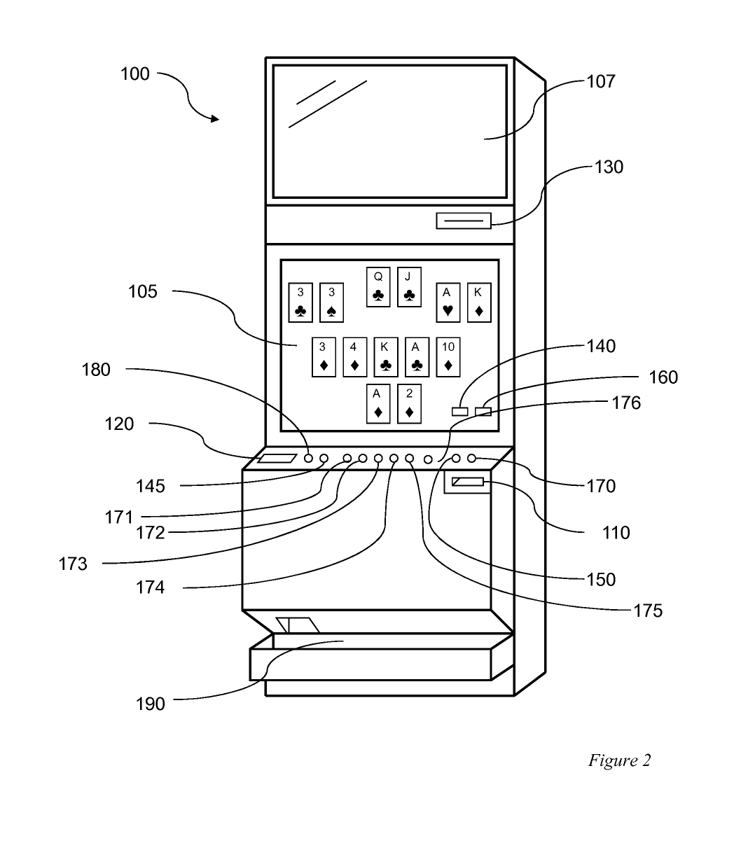

In addition to the gaming table 50 illustrated in FIG. 1, the present invention may also be deployed on a gaming device 100 as illustrated in FIG. 2. Gaming device 100 has the features of a conventional slot machine. The gaming device 100 shown in FIG. 2 is what is commonly referred to as an upright slot machine and the player can operate it while standing or sitting. Most often the gaming device 100 is preferably mounted on a stand. (Not shown.) Although an up-right slot machine is shown in FIG. 2, it can be appreciated that the gaming device 100 can be any other style of gaming machine known in the art including, but not limited to a pub-style table-top or slant-top game which a player can operate while sitting. The gaming device 100 can be constructed with varying cabinet and display designs.

Gaming device 100 can incorporate any primary game including, but not limited to the present invention, reel slots, traditional video poker, blackjack, keno or bingo. Gaming device 100 shown in FIG. 2 has a video display 105 for displaying symbols such as playing cards used in the present invention.

It should be appreciated that the display devices may display any visual representation or exhibition, including but not limited to video images or movement of physical objects. The display devices can be a video monitor or screen, a liquid crystal display or any other display mechanism. Furthermore, it should be appreciated that these display devices may preferably include touch screens.

As shown in FIG. 2, gaming device 100 preferably includes one or more wager accepting mechanisms. The primary wager accepting mechanism on the gaming device 100 shown in FIG. 2 may be a bill validator 110. The bill validator 110 may also accept other forms of payment including, but not limited to tickets, smart cards, debit cards and credit cards. Alternatively, some of these forms of payment may be accepted through a card reader 130. The card reader 130 may include any type of card reading device, such as a magnetic card reader or an optical card reader. The player will insert a card, such as a player tracking card or a credit card into the card reader 130 which will then read data from the card. The card reader 130 may be used to read and/or write from and/or to the inserted card. There may also be a coin slot 120 on the gaming device 100 in which a player can insert coins or tokens.

After a player inserts money in the gaming device 100, either via the coin slot 120, the bill validator 110 or the card reader 130, a number of credits corresponding to the amount deposited is shown in a credit display 140. After money is credited to the machine 100 and shown on the credit display 140, the player then determines the wager amount. The machine 100 may have any number of mechanisms known in the art for allowing a player to determine his wager. As the player is selecting the wager amount, this wager amount is displayed on a bet display 160. As the bet display 160 amount is incrementing, the credit meter 140 amount is decreasing by the corresponding amount.

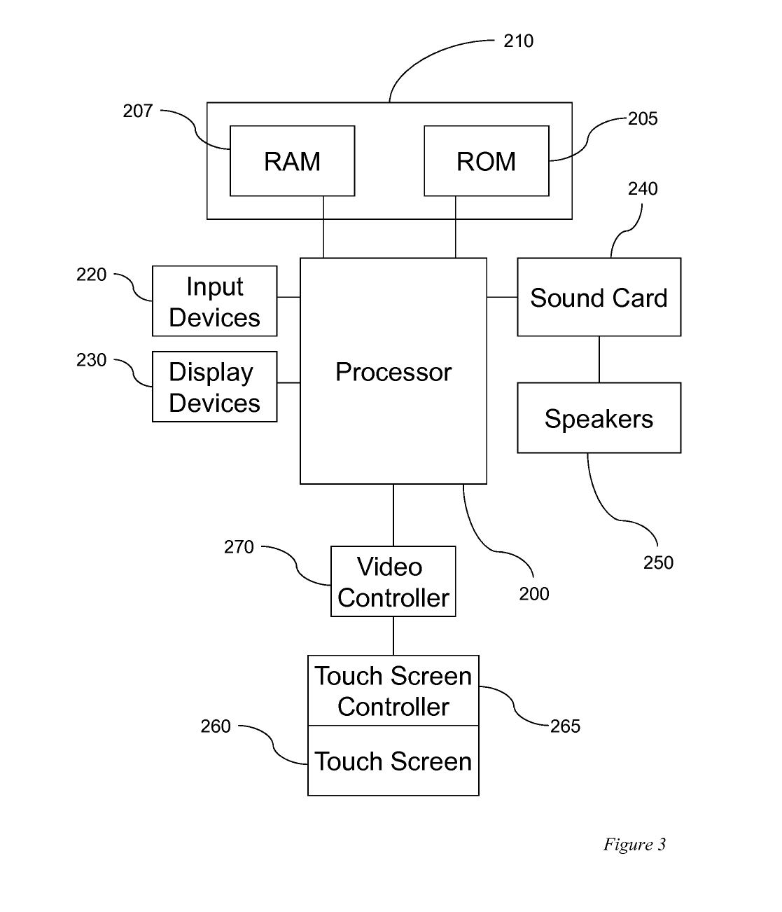

FIG. 3 is a block diagram of the general electronic configuration that may be incorporated in gaming device 100. The configuration preferably includes a processor 200. The processor 200 is preferably a microcontroller-based platform or microprocessor which is capable of displaying images, symbols and other indicia such as images of people, characters, places, things and faces of cards. One or more secondary processors may also be employed in conjunction with the primary processor to control certain aspects of the game function.

The gaming device 100 also includes a memory device 210 for storing program code or other data. This memory device 210 can include both read only memory (ROM) 205 and random access in (RAM) 207. One of the functions performed by a program or sub-program in the processor 200 may be a random number generator (RNG) using any of several methods known to those skilled in the art. In addition to the memory device 210, the electronic configuration of the gaming device 100 may also include one or more input devices 220, one or more display devices 230, a sound card 240, and one or more speakers 250.

The input devices 220 may include but are not limited to a deal/draw button 145, a be one credit button 170, a max bet button 150 and a cash out button 180. Initiating the cash out button 180 may result in the player's balance from the credit meter 140 being deposited into a tray 190 in the form of coin, cash, a ticket or any other suitable media. Additional buttons 171, 172, 173, 174. 175 and 176 may be provided for arranging the player's starting hands. In situations where a touch screen 260 is used, a touch screen controller 265 and touch screen 260 are connected to a video controller 270 and the processor 200.

Although FIG. 3 shows the processor 200 and memory device 210 residing on the gaming device 100, it should be appreciated that it is possible for both the processor 200 and memory device 210 to reside at a central location instead of at the gaming device 100. In such a situation, a network server may be used to communicate to the gaming device over an Internet connection, local area network (LAN), or wide area network (WAN). The processor 200 and memory device 210 are generally referred to herein as the controller.

In addition to the wagers placed in the wager circles 64, players may also place hat are known as “side wagers.” These wagers may result in a payout in addition to the standard payout indicated by the legend 66 or the pay table if the player's hand is of a specified ranking, e.g., a royal flush. The side wager may be associated with a single specific starting hand or all of the starting hands. Additionally, the player may be awarded a payout for a side wager even if the player lost the associated starting hand. For instance, the player may receive an award for a side wager if he makes a straight flush even though the house beat his hand with a higher straight flush.

In addition to the payouts already discussed, the present invention may offer a payout for what is commonly known as a “Bad Beat.” Bad Beat jackpots have been offered to poker players in live card rooms for sometime. Typically these jackpots are progressive in nature (although they may be of a predetermined fixed amount) and are awarded to a player that loses with a very powerful poker hand (for instance Four of a Kind or a Straight Flush). In some situations, a percentage of the progressive amount is also awarded to the player that had the better hand and another percentage may be awarded to the other players at the table or in the card room. (For instance, a Bad Beat may award the player with the losing hand 50% of the jackpot, the player with the winning hand 30% of the jackpot, the other players at the table may split 10% of the jackpot and the other players in the card worn at different tables may split the remaining 10% of the jackpot.) In games like Hold 'Em where the players all use common community cards, there may also be requirements that one or both of the player's starting cards must play. Because the player of the present invention is playing against, a house hand, it would be quite simple to add a Bad Beat jackpot to a game employing the present invention. Preferably, this jackpot would be a progressive amount that increases as the play on the game continues and multiple tables 50 or gaming devices 100 could be linked in a manner well known in the art to provide for even larger and faster growing jackpots. Like the Bad Beats offered in card rooms, the player may either win the entire jackpot when he has a hand of a given rank that is beaten or he may win a portion of the jackpot for either having his hand beaten, beating a powerful hand, or playing at the same table 60—or in the case where multiple gaming machines 100 or tables 60 have been linked—being involved in a game when another player on another gaming machine 100 or table 60 experiences a Bad Beat. It should be appreciated that the initial jackpot amount of the Bad Beat and the rate at which any progressive amount is increased can be adjusted to adjust the total expected payback percentage to the player. The addition of the Bad Beat may also change the optimal strategy involved for any given game and the strategy will likely change as the progressive amount increases. The Bad Beat may be funded from the primary wagers placed in the wager circles 64. Alternatively, the player may have to place a separate wager that is specific to the Bad Beat in order to be eligible.

An insurance wager is another side wager that may be provided in alternative embodiments. An insurance wager allows a player to proceed to at least one subsequent hand even if the prior hand was lost. When this occurs, the insurance has been “used” or “utilized.” Thus, if none of the hands lose to the house, the insurance may go unused. The player may be required to place the insurance wagers prior to reviewing the player's initial group of cards. Alternatively, the player may be allowed to place the insurance wager(s) after seeing either their cards or the dealer's cards, or a portion thereof.

Various possible insurance wagers will now be discussed while generally referring to the preferred embodiment where the player receives an initial hand of six cards and separates those cards into three two-card Hold 'Em starting hands. If an insurance wager was placed that covered the first hand, and the player lost the first hand, the play would still continue to the step of evaluating the second hand against the house's hand. The insurance wager may be specific to one associated starting hand, or in alternative arrangements, it may cover all of the starting hands. In embodiments where an insurance wager is associated with one specific starting hand, each of the first two primary wager circles 64 may have an associated insurance wager circle [xx]. Thus, in the foregoing example where the player lost the first hand, but it was insured, the player would have had to have placed an insurance wager in the insurance wager circle [xx] that corresponds to the first hand. In the embodiments where a single insurance wager may cover multiple hands, a single insurance wager circle [xx] may be provide that is not associated with any single hand.

The amount of the insurance wager that is required or allowed will, in most embodiments, preferably be in relation to the amount of the primary wager(s). In determining the amount that the player is required to wager as insurance, the house will take into account a number of factors in order to reach the desired theoretical hold. These factors will include, but are not necessarily limited to whether the insurance wager covers one or more hands, whether the utilization of insurance will result in a reduced payout for winning subsequent hands, under what circumstances the house collects the insurance wager and at what time the player is allowed to make the insurance wager. Each factor will now be discussed briefly in turn so that the reader will appreciate the various embodiments that may occur from the addition of one or more insurance wagers.

The first factor to consider is whether the insurance wager is associated with a specific hand (e.g., whether it covers one or more hands). In situations where the insurance wager is specific to one hand, the house can generally require the player to wager less to receive insurance. Conversely, where a single insurance wager is capable of being used by multiple hands, the house will generally require the wager to be larger. Thus, if all three primary wagers are required to be the same (e.g. $10 each), the house may require a hand-specific insurance wager to be the same a the primary wager. In other words, the player would have to put up an extra $10 to insure the first hand and $10 more to insure the second hand. In such a case, the player may be able to insure the second hand without insuring the first hand. However, if a single insurance wager would cover a kiss on either the first or second hand, the house may require the player to put up a larger single wager (e.g., $15). This insurance wager would allow the player to possibly receive a payout for the third hand if the player either lost the first hand and won the second hand or won the first hand and lost the second hand. But the $15 wager would not entitle the player to have the third hand evaluated in the situation where the player loses the first hand AND the second hand. If the single insurance wager is allowed to cover a loss on both the first and second hands simultaneously, the house may need to require the player to wager a larger amount (e.g. $20).

The second factor to consider is whether the utilization of insurance will result in a reduced payout for winning subsequent hands. For instance, in a preferred embodiment, the player may receive 1× the first hand wager for winning the first hand, 3× the second hand wager for winning the second hand and 6× the third hand wager for winning the third hand. But in some embodiments, when insurance is offered, the utilization of the insurance may lower the payouts for one or more subsequent hands. If the insurance wager is made, but the insurance is not utilized, the payouts would preferably be unaffected. In one preferred embodiment, all payouts subsequent to insurance usage may be lowered to 1× the wager. Thus, if the player has an insurance wager that covers the first hand, but loses the first hand and wins the second and third hands, the player would only be paid even money on the wagers associated with the second and third hands. Any number of variations on this mechanism are possible. For instance, where insurance is used on the first hand, the player could receive 1× and 6× for winning the second and third hands respectively (where there is no reduction in payout in the third hand). The amount of the reduction in subsequent payouts therefore determines the value of the insurance. The less valuable the insurance is, the less the house would need to charge for it.

The third factor to consider is under what circumstances the house collects the insurance wager. Preferably, the house will collect the insurance wager each time the wager is made. However, the house may choose to not collect the insurance wager when there is a tie, when the player uses the insurance, when the player doesn't use the insurance, or any combination of two out of three of the foregoing. The more often the house collects the insurance wager, the smaller the wager can be in relation to the primary wagers.

The fourth factor to consider when determining the required size of the insurance wager is when the player is allowed to make the insurance wager. In the preferred insurance variation, the insurance wager must be made prior to the player receiving any cards. However, the wager may be allowed after the player receives and reviews one or more of their cards or after the player sees one or more of the dealer's cards. As the player is provided more information about either his hand or the dealer's hand, he will be able to better gauge whether or not the insurance will be used (e.g., of value). Thus, as the amount of information available to the player at the time the insurance wager increase, the price the player would need to pay for the insurance wager also increases.

In yet another series of embodiments, the player may be offered the option of surrendering after reviewing one or more of his cards and/or one or more of the dealer's cards. “Surrender,” in this context means paying some amount in exchange for terminating the game early and reclaiming some portion of the total amount wagered. For instance, where three primary wagers of equal value are placed, the player may be allowed to surrender two oldie wagers in exchange for being allowed to keep one of the wagers. The exact mown that is required to be surrendered will primarily be a function of the desired theoretical house advantage as well as what information is available to the player at the time that the decision to surrender is made (similar to considering the insurance wager).

Other combinations, orders of operation, additions and modifications to the foregoing may also be made without departing from the scope of the present invention. Thus, the foregoing should be considered illustrative rather than limiting the invention, which is defined only by the following claims.

What is claimed is:

1. A method of playing a game of poker utilizing a deck of physical playing cards comprising:
(a) accepting at least N wagers from a player on a table, where N is at least greater than one;
(b) dealing a number of player cards to the player from the deck, the number of said player cards being sufficient to form at least N player starting hands;
(c) allowing the player to organize the player cards into N player starting hands, each of said N player starting hands designated as a first through Nth player starting hand, wherein each of said player starting hands is associated with at least one of said wagers;
(d) dealing a number of house cards to the house from the deck, the number of said house cards being sufficient to form at least a single house starting hand;
(e) organizing the said house cards into a single house starting hand and discarding the remaining house cards;
(f) dealing community cards;
(g) completing a house poker hand using the single house starting hand and said community cards;
(h) completing at least a first poker hand of the player using the first player starting hand and said community cards;
(i) comparing the completed first poker hand of the player to the completed house poker hand;
(j) awarding the player a payout based on the first wager if the player's completed first poker hand is superior to the completed house poker hand.
(k) repeating steps (h) through (j) for the second through Nth player starting hands and second through Nth wager.

2. The method of claim 1 wherein the steps (h) through (j) are repeated for the second through Nth player starting hands until either one of the player's completed hands is inferior to the house poker hand or the player has received an award for all N starting hands.

3. The method of claim 2 wherein if a player's completed nth poker hand is interior to the house poker hand, each wager associated with the nth through Nth poker hand is collected by the house.

4. The method of claim 3 wherein the amount of the payout awarded to the player is determined, at least in part, by a pay table.

5. The method of claim 4 wherein there is a plurality of pay tables and the specific pay table used to determine the size of the award is dependent, at least in part upon the nth poker hand being compared.

6. The method of claim 5 wherein the number of wagers is equal to N and each wager is associated with exactly one of said N starting hands and each wager is of equal value.

7. The method of claim 6 wherein the game of poker is Hold 'Em, such that each player starting hand contains two cards, and the steps of completing each hand is performed by dealing five community cards from which the player and house make their best five-card poker hands.

8. The method of claim 7 wherein N is equal to three and the number of player cards is six.

9. The method of claim 8 wherein the amount awarded to the player for a superior first poker hand is equal to the wager associated with, the first poker hand, and the amount awarded to the player for a superior second poker hand is equal to three times the wager associated with the second poker hand, and the amount awarded to the player for a superior third poker hand is equal to six times the wager associated with the third poker hand.

10. The method of claim 9 wherein the step of dealing a number of house cards to the house involves dealing six cards to the house from which the house forms a two-card starting hand.

11. The method of claim 1 wherein the player receives a jackpot if he has a Bad Beat.

12. The method of claim 11 wherein the jackpot is a progressive.

13. The method of claim 1 wherein the player may place a secondary wager associated with one or more of the N starting hands and wherein the player receives a secondary award if the associated starting hand is of a specified rank.

14. A method of playing a game of poker utilizing playing cards comprising
(a) accepting at least three wagers from a player;
(b) dealing at last six player cards to the player;
(c) allowing the player to organize the player cards into at least three starting hands of two player cards each, each of said player starting hands designated as a first through third player starting hand, wherein each of said player starting hands is associated with at least one of said wagers;
(d) dealing a number of house cards to the house, the number of said house cards being sufficient to form at least a single house starting hand of at least two cards;
(e) organizing the said house cards into a single house starting hand of at least two cards and discarding the remaining house cards;
(f) dealing community cards;
(g) completing a house poker hand using the single house starting hand and said community cards;
(h) completing at least a first poker hand of the player using the first player starting hand and said community cards;
(i) comparing the completed first poker hand of the player to the completed house poker hand;
(j) awarding the player a payout based on the first wager if the player's completed first poker hand is superior to the completed house poker hand.
(k) repeating steps (h) through (j) for the second through third player starting hands and second through third wager.

15. The method of claim 14 wherein the steps (h) through (j) are repeated for the second through Nth player starting hands until either one of the player's completed hands is inferior to the house poker hand or the player has received an award for all N starting hands.

16. The method of claim 15 wherein if a player's completed nth poker hand is inferior to the house poker hand, each wager associated with the nth through Nth poker hand is collected by the house.

17. The method of claim 16 wherein the amount of the payout awarded to the player is determined, at least in part, by a pay table.

18. The method of claim 17 wherein there is a plurality of pay tables and the specific pay table used to determine the size of the award is dependent, at least in part, upon the nth poker hand being compared.

19. The method of claim 18 wherein the number of wagers is equal to N and each wager is associated with exactly one of said N starting hands and each wager is of equal value.

20. The method of claim 19 wherein the game of poker is Hold 'Em, such that each player starting hand contains two cards, and the steps of completing each hand is performed by dealing five community cards from which the player and house make their best five-card poker hands.

21. The method of claim 20 wherein N is equal to three and the number of player cards is six.

22. The method of claim 21 wherein the amount awarded to the player for a superior first poker hand is equal to the wager associated with the first poker hand, and the amount awarded to the player for a superior second poker hand is equal to three times the wager associated with the second poker hand, and the amount awarded to the player for a superior third poker hand is equal to six times the wager associated with the third poker hand.

23. The method of claim 22 wherein the step of dealing a number of house cards to the house involves dealing six cards to the house from which the house forms a two-card starting hand.

24. The method of claim 14 wherein the player receives a jackpot if he has a Bad Beat.

25. The method of claim 24 wherein the jackpot is a progressive.

26. The method of claim 14 wherein the player may place a secondary wager associated with one or more of the N starting hands and wherein the player receives a secondary award if the associated starting hand is of specified rank.
